(19) United States
(12) Patent Application Publication
(10) Pub. No.: US 2012/0094639 A1
(43) Pub. Date: Apr. 19, 2012

(54) HEAT MAPS APPLYING LOCATION-BASED INFORMATION TO TRANSACTION PROCESSING DATA

(76) Inventors: Mark Carlson, Halfmoon Bay, CA (US); Surendra Keshan, Cupertino, CA (US)

(21) Appl. No.: 13/274,231

(22) Filed: Oct. 14, 2011

Related U.S. Application Data
(60) Provisional application No. 61/393,753, filed on Oct. 15, 2010.

(51) Int. Cl. H04W 4/02

(52) U.S. Cl. 455/414.1

(57) ABSTRACT

Embodiments of the present invention relate to determining the location of an enrolled account holder using a mobile device, such as a mobile phone, that is associated with the cardholder's transaction account in a location-based system (LBS). The mobile device is used to determine the approximate location of the account holder at the time of the transaction, for example, by using cellular tower triangulation. Location data, such as geographic coordinates, may be combined with transaction data. The combination of transaction data and location data can be used to generate heat maps showing transaction, spending, and fraud patterns, among other data.

### CROSS-REFERENCES TO RELATED APPLICATIONS

The present application is a non-provisional application of and claims priority to U.S. Provisional Application No. 61/393,753, filed on Oct. 15, 2010, the entire contents of which are herein incorporated by reference for all purposes.

### BACKGROUND

The field of the invention is related to location data describing the location of a consumer and transaction data from a transaction using a portable consumer device, such as a credit card.

### BRIEF SUMMARY

Embodiments of the present invention relate to determining the location of an enrolled account holder using a mobile device, such as a mobile phone, that is associated with the cardholder's transaction account in a location-based system (LBS). The mobile device is used to determine the approximate location of the account holder at the time of the transaction. Embodiments of the present invention relate to a combination of location data, such as geographic coordinates, and transaction data, such as transaction history, information about the current transaction, purchaser's purchase tendencies, purchaser's preferred retailers/merchants, purchaser's disposable income, time spent in stores, etc.

The combination of transaction data and location data can be used to generate heat maps. A heat map can be a graphical representation of data where the values taken by a variable in a two-dimensional map are represented as colors or gradient patterns. Heat maps may be time-based, capturing activity over a certain time interval in a given area.

A method is described herein of generating electronic heat maps using location data and transaction data comprising: receiving a first electronic message containing transaction data associated with a transaction account after a portable consumer device of an account holder is used for payment in a transaction; receiving a second electronic message containing location data describing the location of a mobile device in the possession of the account holder and associated with the portable consumer device of the account holder; analyzing, with a server computer, the location data and transaction data with a computer server and generating location-based transaction information; and generating, with the server computer, an electronic heat map using the location-based transaction information. The heat map may represent consumer spending in a particular geographic area or consumer spending over a particular period of time. The location data is derived from cellular tower triangulation. The method may further comprise electronically transmitting at least a portion of the heat map to an issuer of a payment account. Heat maps may be used to predict consumer behavior based on location-based transaction information, including determining a merchant that a consumer is likely to next visit based on prior location-based transaction information. The heat map may be used to update a database of active spend zip codes, map locations of a plurality of merchant terminals, or map fraudulent transactions.

A server computer is described herein for generating electronic heat maps using location data and transaction data comprising: a transaction message parser module for receiving an electronic transaction message indicating that a transaction has been initiated using a portable consumer device, wherein the electronic transaction message comprises transaction-specific data; an enrollment database containing a plurality of enrollment records, each enrollment record comprising a portable consumer device identifier; a mobile device lookup module for determining a mobile device identifier based on the portable consumer device identifier; a location query module, wherein the location query module is in operative communication with at least one cellular service provider capable of returning location data; a transaction-location database that correlates the location of the mobile device and the transaction-specific data; and a heat map data generation unit that generates a heat map based on the transaction-specific data. The heat map may represent consumer spending in a particular geographic area and over a particular period of time. The location data is derived from cellular tower triangulation. The server computer may further comprise a merchant portal for a merchant to access the heat map or an issuer portal for an issuer to access the heat map.

A method is described herein of generating electronic heat maps using location data and transaction data comprising: receiving an electronic transaction message indicating that a transaction has been initiated using a portable consumer device, wherein the electronic transaction message comprises transaction-specific data; determining, using a server computer, a mobile device associated with the payment account using the electronic transaction message; initiating a location query, wherein the location query determines the location of the mobile device using cellular tower triangulation; electronically correlating the location of the mobile device and the transaction-specific data; and generating a heat map data point based on the correlation of the location of the mobile device and the transaction-specific data and recording the heat map data point to a heat map database. The transaction-specific data may comprise a transaction account identifier, a transaction amount, or a transaction time stamp. The location of the mobile device comprises latitude and longitude coordinates or street address or zip code. The heat map may represent spending in a particular geographic area over a particular period of time by credit card issuer.

A server computer is described herein for generating electronic heat maps using location data and transaction data comprising: a transaction message parser module for receiving an electronic transaction message indicating that a transaction has been initiated using a portable consumer device, wherein the electronic transaction message comprises transaction-specific data; an enrollment database containing a plurality of enrollment records, each enrollment record comprising a portable consumer device identifier; a mobile device lookup module for determining a mobile device identifier based on the portable consumer device identifier; a location query module, wherein the location query module is in operative communication with at least one cellular service provider capable of returning location data using cellular tower triangulation; a transaction-location database that correlates the location of the mobile device and the transaction-specific data; and a heat map data generation unit that generates a heat map based on the correlation of the location of the mobile device and the transaction-specific data. The heat map may represent declined transactions over a particular period of time, transaction volume, transaction volume by high dollar purchases in a specific geographic area, or velocity of spending. The location data may comprise latitude and longitude coordinates or a street address or zip code. The server computer may further comprise an issuer portal for an issuer to access the heat map or a merchant portal for a merchant to access the heat map. The merchant portal may provide a user interface for the merchant to manipulate the heat map by zooming in, zooming out, changing the geographic area depicted by the heat map.

These and other embodiments of the invention are described in further detail below.

### BRIEF DESCRIPTION OF THE DRAWINGS

FIG. 1 shows a location-based system in accordance with an embodiment of the present invention.

FIG. 2 shows a location-based system in accordance with an embodiment of the present invention.

FIG. 3 shows a method of generating heat maps in accordance with an embodiment of the present invention.

FIGS. 4A-C show heat maps in accordance with embodiments of the present invention.

FIGS. 5A-C show heat maps in accordance with embodiments of the present invention.

FIG. 6 shows a heat map user interface in accordance with an embodiment of the present invention.

FIG. 7 shows a merchant terminal map in accordance with an embodiment of the present invention.

FIG. 8 shows a consumer enrollment portal in accordance with an embodiment of the present invention.

FIG. 9 shows a block diagram of an exemplary computer apparatus that may be used in accordance with embodiments of the present invention.

### DETAILED DESCRIPTION

Embodiments of the present invention relate to determining the location of an enrolled account holder using a mobile device, such as a mobile phone, that is associated with the cardholder's transaction account in a location-based system (LBS). The mobile device is used to determine the approximate location of the account holder at the time of the transaction. Embodiments of the present invention relate to a combination of location data, such as geographic coordinates, and transaction data, such as transaction history, information about current transactions, purchaser's purchase tendencies, purchaser's preferred retailers/merchants, purchaser's disposable income, time spent in stores, etc.

In one embodiment, the high-level process flow is as follows:
Consumer enrolls mobile device (e.g., mobile phone) and associates mobile device with a transaction account associated with a portable consumer device (e.g., credit card);
Consumer uses transaction account to pay for goods or services (e.g., swipe card at POS terminal; or enters card information at e-commerce merchant);
Authorization for the transaction is processed;
Consumer is located using LBS system;
Transaction data and location data are combined; and
The combined transaction-location data may be used to generate a heat map, update a merchant location database, predict a particular consumer behavior or the behavior of a group of consumers, etc.

Any transaction data used in a payment processing network could be combined with location data for useful results. A payment processing network may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

Data describing a location is referred to as “location data.” Location data may be a longitude and latitude coordinate, a city, a state, or a zip code, or any other type of information that describes a location. Location data can be combined with transaction data, such as transaction history and current transaction information, for a number of beneficial results, including but not limited to advertisements, marketing, fraud protection, and data collection.

The LBS may use cell tower triangulation to determine the approximate location (current or last known) of a mobile device. The mobile device may be associated with a transaction account when a cardholder (who uses the mobile device) enrolls in the LBS program. Localization may occur using multilateration of radio signals between one or more radio towers of the network and the mobile device. To locate the phone using multilateration of radio signals, the phone may emit a roaming signal to contact nearby antenna tower(s). For example, the distance of the cellular phone to the tower can be estimated based upon the lag time between when the tower sends a message to the phone and receives the answering message back.

The greater the number of cell towers receiving a phone's signal allows for greater degrees of accuracy. In densely developed or urban areas, the accuracy of cell tower triangulation may be very high because there are typically more cell towers with their signal coverage areas overlapping (50 m or better). Cellular tower triangulation also is advantageous when a cell user is inside large structures or underground and a GPS signal cannot be maintained. This is very common in an in-person retail transaction setting. In this circumstance, cell tower triangulation may be the only location pinpointing method available. Cellular tower triangulation-based location determination (opposed to GPS) is less accurate and therefore may be viewed as less intrusive by the customer. Similarly, cellular tower triangulation can be done without active participation from the consumer, as is required by some GPS implementations.

In other embodiments, the LBS may use global positioning systems (GPS) in a mobile device to determine the cardholder's location. Mobile devices, equipped with Global Positioning System (GPS) capability, use signals from satellites to pinpoint location very accurately (20 m or better).

If privacy is a concern, it is preferred that the enrolled cardholder's location is queried only when necessary and useful and beneficial to the customer. In some embodiments, the most relevant and useful location data will be presented when a cardholder is making a purchase. Therefore, when an enrolled cardholder makes a purchase, the location-based system may determine the location of the mobile device. For example, the LBS may query an agent of the mobile device, such as a telecommunication provider (e.g., AT&T or Verizon) or a third party in operative communication with a telecommunication provider (e.g., a mobile aggregator). In other embodiments, the LBS may send a message to the mobile device requesting location.

The combination of transaction data and location data can be used to achieve a number of useful results, including but not limited to generating heat maps depicting numerous spending patterns, customer behavior based on past transaction and location history, merchant locations and merchant terminal locations, etc.

Heat Maps

The combination of transaction data and location data can be used to generate heat maps. The aggregate location and transaction data of many enrolled cardholders can be used to generate heat maps. The location and transaction data of a particular consumer may be used to generate a heat map for that consumer. A heat map can be a graphical representation of data where the values taken by a variable in a two-dimensional map are represented as colors. Heat maps may be a graphical representation of data using colors to indicate the level of activity. Usually darker colors to indicate low activity, and lighter/brighter colors to indicate high activity, but the reverse color/brightness convention could also be used. For example a heat map could indicate the number of spending patterns in a geographical area during a set period of time.

Heat maps may be time-based. That is, heat maps may capture activity over a certain time interval in a given area. For example, the heat map can capture the locations where money is spent during early hours versus where money is spent during lunch time or after work. Similarly, money spending patterns on weekends may differ from weekday patterns, and heat maps of the present invention may capture this information. Variation in heat over time may be shown by generating multiple heat maps (e.g., one every minute or every hour) and allowing a data analyst to “scrub” a heat map timeline through numerous heat map snapshots. Scrubbing refers to manually scrolling through time-based snapshots of a heat map (forward and backward), viewing individual snapshots, and pausing at times for further analysis. Spending velocity may also be captured and depicted in heat maps of the present invention. Any measurement of time is possible. Time intervals may be minutes, hours, days, weeks, months, years, etc.

Exemplary Systems

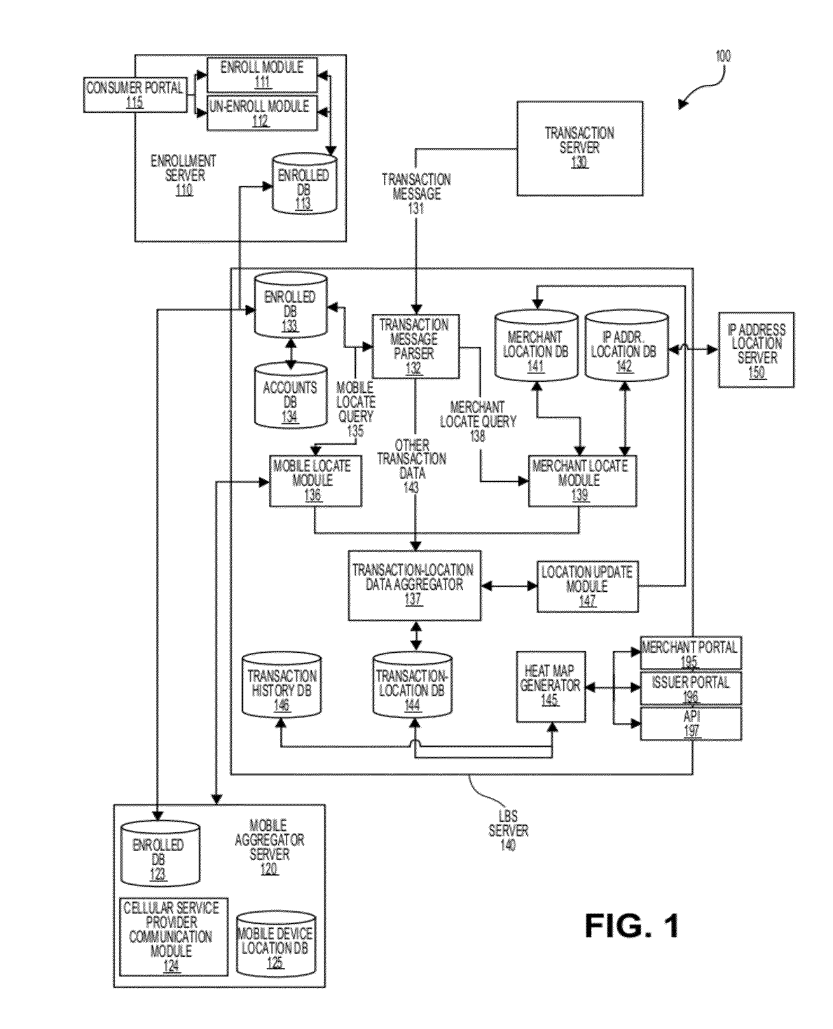

FIG. 1 shows a location-based system (LBS) 100 in accordance with embodiments of present invention. The location-based system 100 comprises an enrollment server 110, a mobile aggregator server 120, a transaction server 130, and an LBS server 140. These components are in operative communication with one another.

The location-based system 100 also comprises various portals for interacting with a user, e.g., a graphical user interface (GUI). The portal may be a software application or a web-based application. The consumer portal 115 may be used to enroll consumers in the LBS program. The consumer may be able to view heat maps of that particular customer's spending patterns. The merchant portal 195 and Issuer portal 196 may comprise a GUI for displaying various heat maps disclosed herein.

Merchants can use the merchant portal as an analytical tool to research and analyze consumer spending patterns and to help merchants decide how to target their offers, rewards, or alerts programs. For example, a merchant may examine a heat map of a particular type of customer or group of consumer that that particular merchant is specifically targeting. Using the various heat maps disclosed herein, the merchant can develop a strategy for targeting those customers. A merchant could also analyze consumer activity near that merchant's locations.

Issuers can use the issuer portal as an analytical tool to reduce fraud. For example, using the portal, issuers can analyze the location of the cardholder, as determined by locating the mobile device, in relation to a heat map showing incidence of fraud. In another example, the location of the cardholder, as determined by locating the mobile device, can be compared to past transactions of that particular consumer. In other examples, a present transaction of a consumer can be analyzed against both a heat map showing past fraud and the particular consumer's past transactions.

An application programming interface (API) 197 allows other internal or external software programs to communicate with each other and serves as an interface between the LBS system and different software programs, and facilitates their interaction. For example, API 191 may provide heat map data to fraud prevention or offers/rewards software platforms.

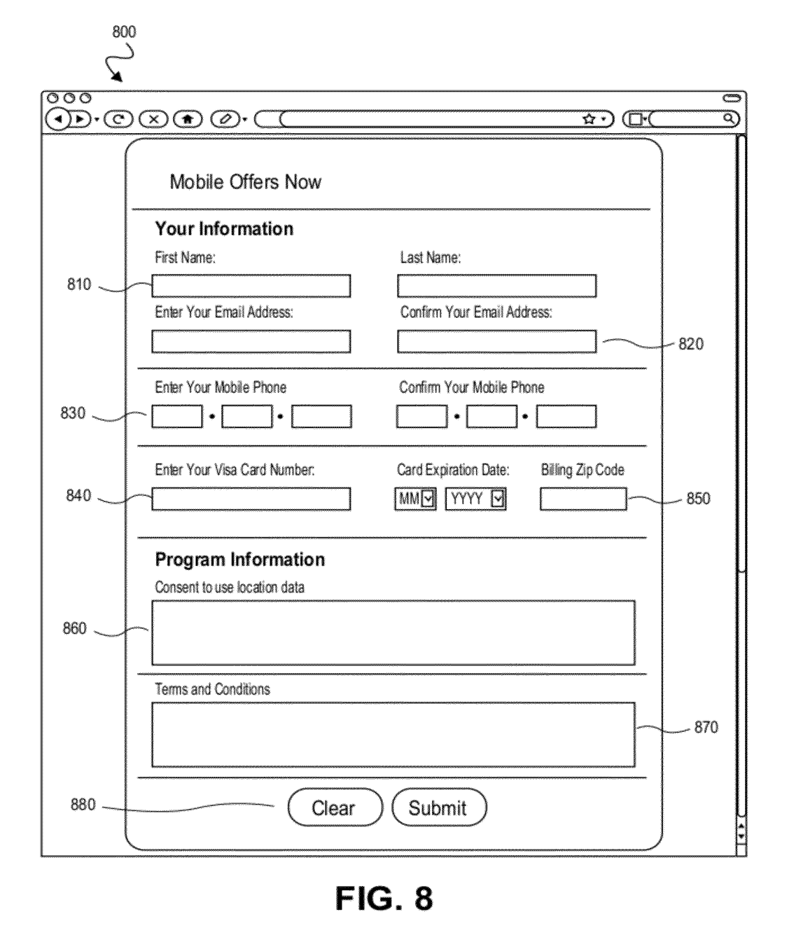

Enrollment server 110 comprises an enroll module 111, and un-enroll module 112, an enrolled consumer database 113, and a consumer portal 115. The consumer portal 115 may be, for example, a website or software application (such as an app on a mobile smart phone) for consumers to send enrollment information to signup or opt-in to the location-based systems described herein. An exemplary enrollment website that may be presented to the consumer is shown below in FIG. 8. In some embodiments, the consumer portal 115 may be a text message interface (e.g., SMS or MMS messaging interface on a mobile device), where the consumer can send and receive messages related to enrolling or un-enrolling in the program. In other embodiments, the consumer portal 115 may be a telephone number or physical location with a customer service agent. The consumer portal 115 could even be an email interface or a traditional mail interface, using a response to an email or a letter or postcard sent through traditional mail (e.g., “respond ‘enroll’ to this email if you would like to participate” or “Please return this postcard to enroll”). Information received at the consumer portal 115 may be sent or input into the enroll module 111 or the un-enroll module 112 for opting into the program or out of the program, respectively.

In the case of consumer enrollment into the program, an enroll message may be electronically transmitted from the consumer portal 115 to the enroll module 111. The enroll message comprises a mobile device identifier (e.g., cellular phone number) and an account identifier (e.g., PAN or consumer name). Upon receipt of an enroll message, the enroll module may query the enrolled database 113 to check whether the mobile device associated with the mobile device identifier is already enrolled. The enroll module may transmit the enrollment information to the enrolled database 113 for storage. The enrolled database 113 contains a current list of all consumer accounts that are enrolled in the program and correlates a mobile device identifier with each enrolled account.

In the case of consumer opt-out, an un-enroll message may be electronically transmitted from the consumer portal 115 to the un-enroll module 112. The un-enroll message may comprise a mobile device identifier and an account identifier. Upon receipt of the un-enroll message, the un-enroll module 112 may send a message to the enrolled database 113 with instructions to delete, delist, or otherwise deactivate the location-based services associated with the particular mobile device identifier and/or the account identifier. Once a consumer is enrolled or un-enrolled, other enrolled databases associated with other components or systems may need to be updated.

The transaction server 130 may serve to notify the LBS server 140 of a particular transaction by sending a transaction message 131. The transaction message 131 is an example of a first electronic message that contains transaction data associated with a transaction account after a portable consumer device of an account holder is used for payment in a transaction. The transaction server may be a payment processing network, merchant, acquiring bank, credit card association, payment network, or another third party.

The transaction message 131 comprises data describing the transaction, the consumer paying for the transaction, the merchant receiving payment for the transaction, and the products or services that are the subject of the transaction. The transaction message may contain data similar to a payment authorization request message. In some embodiments, the transaction message is an authorization request message. Even though the transaction message is described as including certain information, one skilled in the art will realize that other types of information in lieu of or in addition to the information described may be included in the transaction message.

Transaction message data describing the consumer involved in the transaction may include the consumer's personal account number (PAN), issuer of the portable consumer device, risk score, or fraud protection data. The transaction message may also comprise a mobile device identifier associated with the consumer or the consumer's PAN, or the mobile device identifier using a lookup module in communication with the enrolled database 133.

Transaction message data describing the merchant involved in the transaction may include a raw merchant name, merchant account, merchant identifier (MID), merchant address, merchant coordinates (latitude and longitude), merchant state, or merchant zip code. A merchant terminal identifier may be included in the transaction message. The merchant terminal identifier can uniquely identify a specific terminal.

Transaction message data describing the transaction itself or products or services that are the subject of the transaction may include a unique transaction ID, transaction amount, transaction date/time, merchant category code (MCC), service code, or other information. For example, a transaction message may contain a range of product identification codes (e.g., universal product codes or UPCs, stock keeping units or SKUs, ISBNs (International Standard Book Numbers), customized product codes, etc.). The transaction message data may comprise information indicating whether the transaction is a card present (CP) or a card not present (CNP) transaction. Similarly, transaction message data may comprise information indicating whether the transaction is an internet sale, telephone sale, or in-person sale. Transaction message data may comprise information indicating whether the purchase was for groceries, restaurants, gasoline, or retail.

Transaction message parser 132 may receive the transaction message 131 from the transaction server 130. The transaction message parser 132 analyzes the transaction message 131 and formats and routes the transaction message data for use in the LBS server 140. Among other things, the transaction message parser 132 locates an account identifier, such as a PAN, and queries the enrolled database 133. The enrolled database may be in operative communication with an accounts database 134. The accounts database may contain further information about payment accounts, for example details about all account holder, whether or not they are enrolled in the LBS program.

If an enrolled account is located in enrolled database 133, transaction message parser 132 may send a mobile locate query 135 to the mobile locate module 136. For example, the transaction message parser may send a message to the mobile locate module asking the location of the mobile device associated with a particular identifier, such as a phone number. The mobile locate module 136 locates the appropriate mobile device and sends the location data to the transaction-location data aggregator 137. The enrolled database 133 may contain similar information to enrolled database 113. In other embodiments, the transaction parser is in operative communication with the enrolled database 113.

Mobile locate module 136 may be in communication with telecommunication providers to enable locating a mobile device associated with a mobile device identifier. In some embodiments, mobile locate module 136 is in communication with a mobile aggregator. The mobile aggregator operates the mobile aggregator server 120, and is in communication with cellular service providers through a cellular service communication module 124. Mobile aggregator server 120 may maintain a mobile device location database 125 of the last know location of a mobile device and this database may be updated in real-time or as part of a periodic batch process. Mobile aggregator server 120 may also comprise a enrolled database 123. The enrolled database 123 may be in operative communication with enrolled database 113 or may contain similar information (account and identifiers of enrolled accounts) that is updated periodically by enrollment server 110 and enrolled database 113.

The mobile locate module 136 may send a locate message to the mobile aggregator server 120. The request comprises a mobile device identifier. Using the mobile device identifier, the cellular service communication provider sends a location request to a wireless provider, such as AT&T, Verizon, Sprint, T-Mobile, etc. The wireless provider returns the mobile device's approximate or last known location or information from which the mobile device's approximate or last known location can be determined. The mobile device's approximate or last known location may then be stored to the database. As indicated by the arrow between mobile locate module 136 and mobile aggregator server 120, the mobile aggregator server returns location data to the mobile locate module 136 in an electronic message. This is an example of a second electronic message that contains location data describing the location of a mobile device in the possession of the account holder and associated with the portable consumer device of the account holder.

Transaction message parser 132 may send a merchant locate query 138 to the merchant locate module 139. For example, the transaction message parser may send a message to the merchant locate module asking the location of the merchant involved in this transaction. In some embodiments, for a card present transaction, the merchant locate module will access a merchant location database 141 with location information for merchants. The merchant location database 141 will return the best known location data for any given merchant. In some cases, only a merchant state, city, or zip code will be known, while in other embodiments geographic coordinates will be known. The merchant location may be updated using location data obtained from a mobile device associated with a specific transaction at that merchant, if the location is determined to be accurate. In other embodiments, for card not present transactions, the merchant locate module may access an IP address location database 142 with location information for merchants or may query another service to determine the location of the IP address used to initiate the transaction. In some embodiments, the IP address location database 142 is in operative communication with an IP address location server 150, which is a service that returns location data for a given IP address.

Transaction message parser 132 may also extract relevant transaction data (143) from the transaction message. Transaction data that is relevant may vary from application to application—for example, products or services being purchased, information about the purchasing consumer, time and date of transaction, amount of transaction, merchant terminal identifier, etc.

Transaction-Location data aggregator 137 takes as input location data from the mobile locate module 136, location data from the merchant locate module 139, and other relevant transaction data (143) from the transaction message parser 132, and associates this data together in a transaction record. The transaction record is stored to a transaction-location database 144 that stores raw data for generating graphical heat maps for display on a user interface.

An example of a particular data point representing the transaction data and the location data of a particular transaction, that may be stored in the transaction-location database 144, includes: transaction ID, primary account number (PAN), mobile device identifier, mobile device location from mobile aggregator, merchant identifier, merchant terminal identifier, and merchant location.

Heat maps may be based on data from the Transaction-Location database 144 as well as other past transactions in the system. Heat map generator 145 generates a heat map from data in the transaction location database 144 and transaction history database 146. Past transaction data is stored in the transaction history database 146. The transaction history database 146 may be obtained, for example, from a payment network, such as VisaNet, or an issuer. Data in the transaction history database 146 may be different from the data in the transaction-location database 144 because the heat map database contains transaction-location data generated by the LBS server based on the location of enrolled mobile devices associated with particular accounts and transactions. The transaction history database 146 contains a greater scope of transaction, and includes transaction data for non-enrolled account holders. Heat map generator 145 takes data from both transaction location database 144 and transaction history database 146 and cross-references the data.

After a sufficient number of transactions, the location update module may determine a more accurate and up-to-date location for a particular merchant. For example, if two or more different transactions occur at a particular POS terminal at a particular merchant return geographic coordinate that are within 100 meters, the merchant location database entry for that particular merchant or merchant POS terminal may be updated by the location update module 147.

For example, if a particular merchant POS terminal only had a zip code as its best available location data, and the transaction-location data aggregator returned a significant number of transactions with approximately the same geographic location data, then the merchant location database 141 may be updated. Now, it is known all transactions that occurred at that particular merchant POS terminal, as stored in transaction history database, may also have that same location. Location update module 147 is in operative communication with the merchant location database 141 and the transaction-location data aggregator 137 and the transaction-location database 144. Location update module 147 updates merchants' location data stored in the merchant location database 141 as better data is learned by the LBS system.

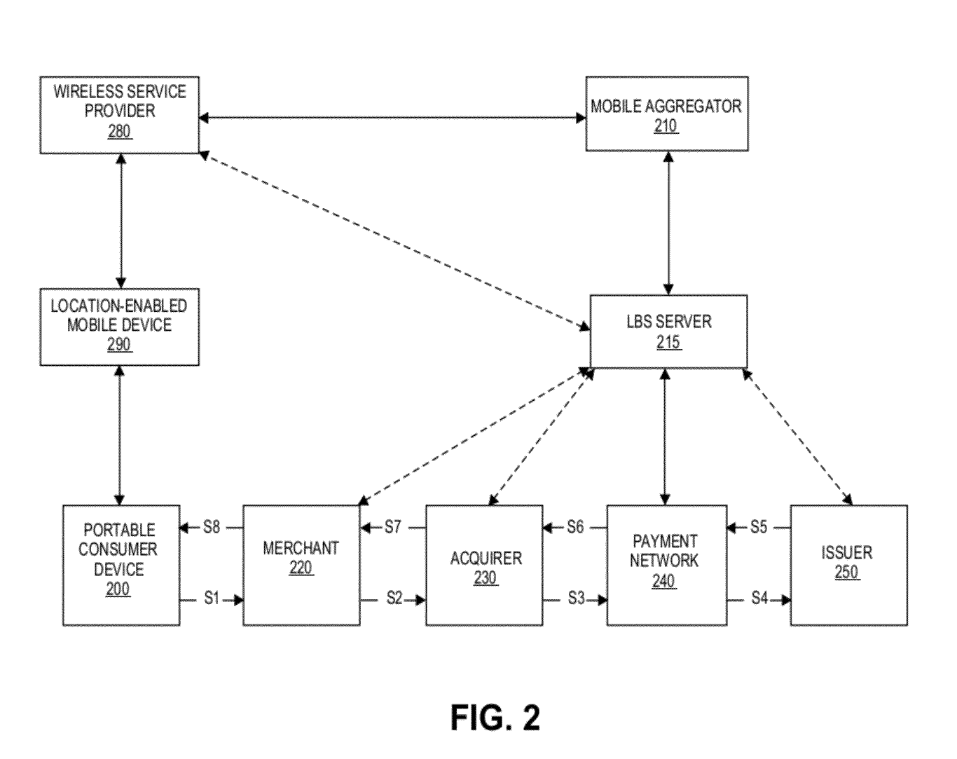

FIG. 2 illustrates how a portable consumer device 200 may be used to make a purchase. A credit card or debit card is one example of a portable consumer device. For example, portable consumer device 200 may be used to make a point of sale (POS) purchase at a merchant 220. The portable consumer device 200 may be used to purchase goods or services at a POS terminal or online in the following manner:
Step 1: Customer offers his portable consumer device 200 towards settling dues;
Step 2: Merchant 220 reads (or, for an online transaction, customer provides) account information from the portable consumer device 200 and submits a transaction to the merchant's acquiring bank 230;
Step 3: Acquiring bank 230 forwards transaction to card association or payment network 240;
Step 4: Payment network 240 processes the transaction request and sends it to the card issuing bank 250;
Step 5: Card issuing bank 250 receives and approves the transaction appropriately and forwards response to payment network 240;
Step 6: Payment network 240 receives response and forwards back to acquiring bank 230;
Step 7: Acquiring bank 230 forwards response to merchant terminal 220;
Step 8: Merchant 220 receives an approval response at terminal.

As mentioned, the merchant 220 has an online sales portal (e.g., a website) that can be accessed through an internet connection. The portable device 200 may be used to make purchases in ways similar to a traditional credit card or debit card.

Portable consumer device 200 is associated with location-enabled mobile device 290 during enrollment. Location-enabled mobile device 200 may be a mobile phone and may be associated with a wireless service provider 280, such as AT&T or Verizon. The wireless service provider 280 can determine the location of the cellular phone 290 without actively querying the phone based on cellar tower triangulation. In some embodiments, a mobile aggregator 210 is in operative communication with a plurality of wireless service providers 280, so that the mobile aggregator can determine the location of mobile phones associated with a plurality of different wireless service providers. In some embodiments (shown by the dashed line), the LBS 215 may be in direct communication with the wireless service provider 280. In other embodiments, the service provider queries the phone. In some embodiments (not shown), a location-enabled mobile device is in operative communication with the payment network 240, so that the payment network 240 may query the mobile device 290 for its location.

The LBS 215 is similar to the LBS server 140, as shown in FIG. 1. The LBS 215 may be in operative communication with one or more of the merchant 220, acquirer 230, payment network 240, or issuer 250. In some embodiments, the LBS 215 may be in communication with one or more of the merchant 220, acquirer 230, or issuer 250 (as shown by the dashed lines).

Methods of Generating Heat Maps

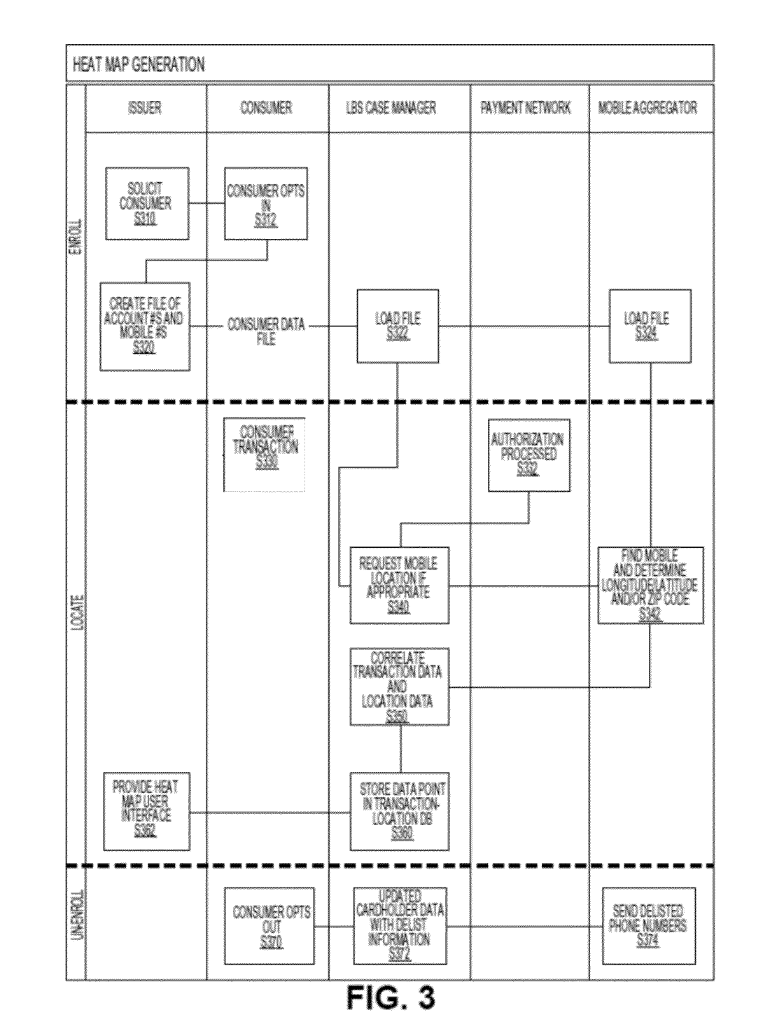

FIG. 3 shows an exemplary method for generating heat maps in accordance with embodiments of the present invention. The numbering of steps is for illustration only, and the steps could be performed in any suitable alternative order. The columns in FIG. 3 labeled “Issuer,” “Consumer, “LBS Case Manager,” “Payment Network,” and “Mobile Aggregator” are intended to show the party that may complete the steps shown. One having skill in the art will realize that other parties could complete certain steps without departing from the scope of the disclosure. For example, the mobile aggregator could be replaced with a wireless service provider.

At S310, an issuer solicits a consumer. Alternatively, a merchant or another third party could solicit a consumer for enrollment into the LBS program. For example, a payment account issuer may send a consumer with an account at the issuer an offer to sign up for location-based services. This solicitation can occur on a website (see FIG. 8), by phone, in person, by text message, by email, or by standard mail. In response to the solicitation, the consumer can opt in at S312. As part of the enrollment process, the consumer provides a mobile device identifier for a mobile device that will be used to periodically check the location of the consumer.

At S320, a consumer data file is created for the particular consumer that enrolled. The consumer data file comprises an account number (e.g., PAN) and a mobile device identifier (e.g., mobile phone number). A load file is provided to the LBS Case Manager at S322 and to the Mobile Aggregator at S324. Providing the consumer load file to the Case Manager and Mobile Aggregator informs the LBS server and the mobile aggregator server 120 of which mobile device the system is permitted to locate.

At S330, an authorization is processed by a payment network. A transaction message, notifying the LBS Case Manager of the transaction, is sent to the LBS Case Manager.

At S340, the LBS Case Manager may request the mobile device location, if appropriate. That is, the LBS Case Manager may determine whether or not the consumer or account associated with the transaction has enrolled in the LBS program by checking an enrollment database. At S342, the Mobile Aggregator locates the mobile device. The Mobile Aggregator may determine the geographic coordinates, such as longitude/latitude and/or zip code. In some embodiments, a distance between the merchant involved in the transaction and the mobile device may be calculated. This distance may be used to determine whether fraud is likely.

At S350, the LBS Case Manager correlates transaction data from the specific transaction with location data from the Mobile Aggregator. For each transaction, this correlation results in a data point that may be stored at S360 in a transaction-location database. After the LBS system has a sufficient amount of correlated transaction and location data, at S362, a heat map may be presented to a user in graphical format.

If a consumer no longer wants his or her location data used, the consumer can opt out at S370. In response to an opt out, the LBS Case Manager updates the consumer data file with the delist information at S372. All or part of the delist information is sent to the mobile aggregator at S374. After consumer opt out at S370, the LBS Case Manager will not request mobile device location, until the consumer opts in again. Similarly, the Mobile Aggregator will not determine the coordinate of the mobile device until notified that the consumer has opted back into the LBS program.

Data Represented in Heat Maps

The combination of transaction data and location data can be used to generate many types of graphical heat maps. Many types of data and subsets of data can be graphically depicted in isolation or in combination with other data in heat maps according to embodiments of the present invention. In some embodiments, heat maps depict activities of a particular consumer. In some embodiments, heat maps depict activities of a particular group of consumers. In other embodiments, heat maps depict patterns associated with particular merchants, account issuers, or the products or services being purchased.

The combination of transaction data and location data can be used to generate heat maps depicting activities of a particular consumer or a group of consumers:
Areas and time where the most money is being spent.
Areas and time with the highest transaction volume.
Areas and time with the highest volume of high dollar purchases.
Areas and time with a dense concentration of high spenders.
Areas with high amount of repeat purchases by consumer.
Transaction volume by merchant over time.
Transaction volume and amount of spending by merchant type or category.
Quantity and mix of spending by channel (online, face-to-face, mail order/telephone order transactions).
Spending velocity.
Transaction velocity.
Spending by financial presentation device type (debit, credit, prepaid).
Average transaction amount of spend.
Percent of wallet by merchant in particular area.
Personal Consumption Expenditures (PCE)—data regarding where a person, family, or group spends money and when a person, family, or group spends their money. For example, percentage of income used to purchase gas at a particular gas station at particular time, percentage of income used for groceries at a particular merchant at a particular time, percentage of income used for entertainment at a particular location at a particular time, percentage of income used at merchant X versus merchant Y.

Heat maps may display data limited to particular consumer, groups of consumers, merchants, or types of merchants:
Activities by consumer that are also enrolled in real-time alerts or offer programs. This would allow merchants to target only consumers who have opted-in to the programs that provide offers, rewards, or discount based on their locations.
Activity shown by issuer (e.g., Citibank). For example, a heat map could be generated that depicts high spenders holding accounts from a particular issuer.
Activity shown by what is purchased (e.g., gas, food, retail, etc.).
Amount of spending by merchant.
Activity analyzed by enrolled cardholder groups (e.g., Visa Signature, Gold, Platinum, rewards program, credit, debit, high spenders, medium spenders, lower spenders, etc.).
Activity demographic information (e.g., age, gender, etc.) as obtained from enrollment or account data.
Activity by type of account (credit, debit; prepaid, reward account, etc.).

Heat Maps may depict consumer behavior on an individual level. For example, heat maps may show:
Where a consumer spends greatest amount of money.
Frequency that a consumer conducts particular types of transactions—CP, CNP, manually keyed in transactions.
Where a consumer shops based on geographic and temporal patterns.

Based on this information, embodiments of the present invention use location and past customer patterns (e.g., Visa transaction history) to predict what store customers will visit next. For example, if a cardholder typically shops at Macy's, then Trader Joe's, then Safeway, then, after cardholder goes to Macy's, offers can be presented to customer for Trader Joe's and/or Safeway. In another example, after a dinner purchase is made at a restaurant, a movie offer could be presented for a nearby cinema.

Embodiments of the present invention may be useful for real time interaction applications. For example, if there is a high concentration of people shopping at a particular location at a particular time, targeted offers can be generated. In one example, Gap and Macy's are competitors. If percent of wallet for particular group/individual is very high for Macy's, then Gap can choose not to target and conversely, if percent of wallet is low for Macy's, then Gap can aggressively target those customers. Using the combination of transaction data and location data to generate targeted offers is less intrusive to the customer, increases the likelihood that the customer will find that the offer is relevant to his/her interests and spending habits, and increases the likelihood that an offer will result in a purchase.

Embodiments of the present invention may be useful for fraud prevention. For example, Visa could use heat maps or heat map-related data to focus Visa's fraud detection services. The combination of transaction data and location data may be used to map:
Merchants, locations, or areas with high use of lost or stolen cards.
Merchants, locations, or areas with high fraud rates.
Merchants, locations, or areas with high decline rates.
Merchants, locations, or areas with high return rates.
Merchants, locations, or areas with high charge back rates.
Merchants, locations, or areas with high exception rates.
Merchants, locations, or areas with high number of disputes.
   The heat maps showing fraud may be time-sliced, meaning a first heat map could show fraud at a first time and a second heat map could show fraud at a second time. This information could then be inputted into various fraud prevention systems. For example, the heat maps could be analyzed by a member of the fraud avoidance team in response to an alert before reaching out to the customer. In other embodiments, the underlying data may be inputted to systems that generate risk and fraud scores before transaction authorization.

One having skill in the art will realize that many combinations of data displayed on a heat map are possible. Any combination of the types of data described herein may be shown on a heat map in accordance with the present invention.

Exemplary Heat Maps and User Interfaces

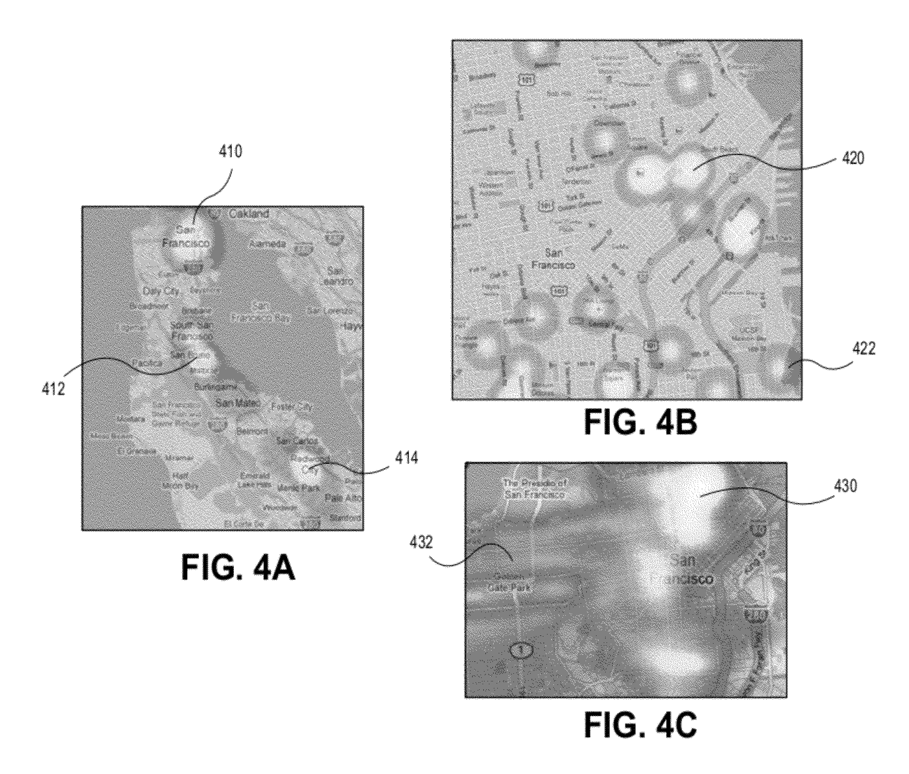

FIGS. 4A-C and 5A-C show various exemplary heat maps and user interfaces. These exemplary heat maps and user interfaces could be presented through a merchant portal 195 or an issuer portal 196, as detailed above.

FIGS. 4A-C show heat maps in accordance with embodiments of the present invention. The data represented in FIGS. 4A-C could be any type of location-transaction data disclosed here in. Specifically, FIG. 4A could illustrate a zoomed out view of transaction activity in the San Francisco Bay Area. At the particular time shown, there is high activity in the San Francisco (410), San Bruno (412), and Redwood City (414) areas. For example, the data represented in FIG. 4A could be transaction volume at 10:00 AM averaged over a year period.

FIG. 4B shows a view of activity in San Francisco. At the particular time shown, there are relatively large “hot spots” at certain locations (e.g., 420) and smaller “hot spots” in other locations (e.g., 422). For example, the data represented in FIG. 4B could be locations where five or more incidences of fraud were reported. A heat map showing incidence of fraud could be used to determine whether or not a given transaction is fraudulent. FIG. 4C shows another view of activity in San Francisco. More activity is occurring in the downtown area (430) and less in the residential areas (e.g., 432). Again, the data represented could be any type of location-transaction data disclosed here in.

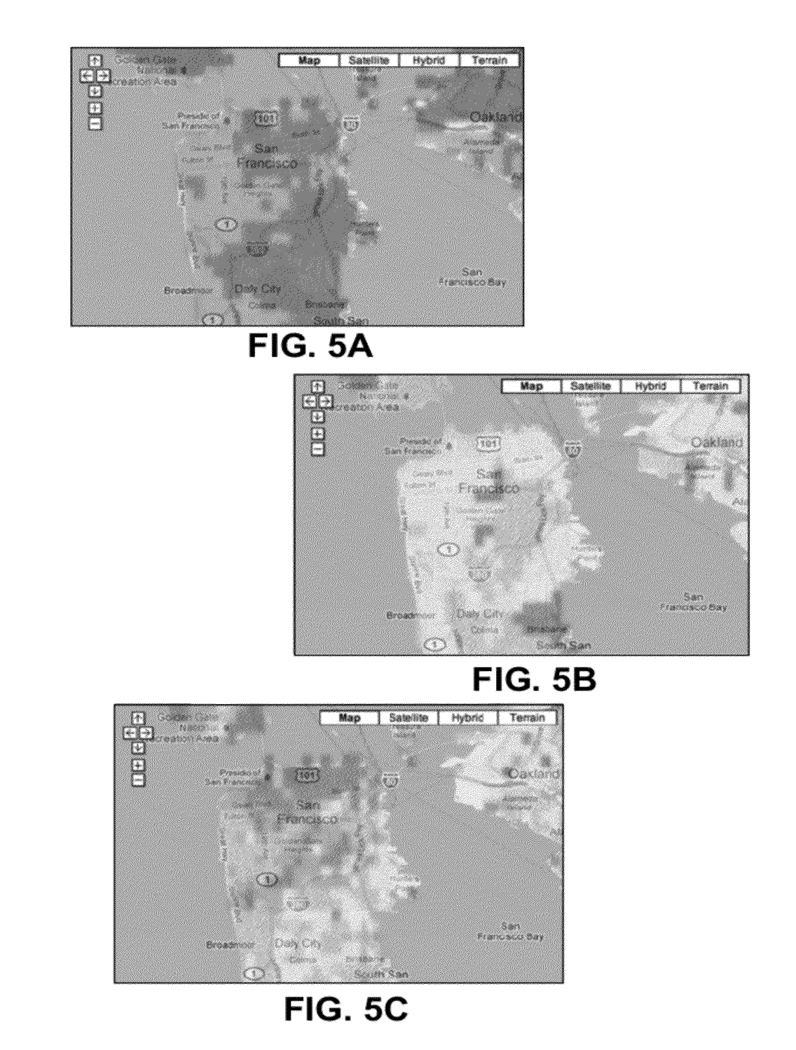

FIGS. 5A-C show activity over a specific geographic area (San Francisco—Oakland area) varied by time. That is, FIG. 5A shows particular transaction activity at a first time, FIG. 5B shows particular transaction activity at a second time, and FIG. 5C shows particular transaction activity at a third time. The activity in FIGS. 5A-C could illustrate where fraud has occurred averaged over time. For example, FIG. 5A may show the incidences of fraud (or where transactions have been declined) at 9:00 AM as averaged over a year time period, FIG. 5B may show the incidences of fraud at 2:00 PM as averaged over a year time period, and FIG. 5C may show the incidences of fraud at 7:00 PM as averaged over a year time period. One having skill in the art will realize that the particular transaction activity could be any type of spending or fraud data disclosed herein. In some embodiments, the view may be a local view. In other embodiments the view is a national view.

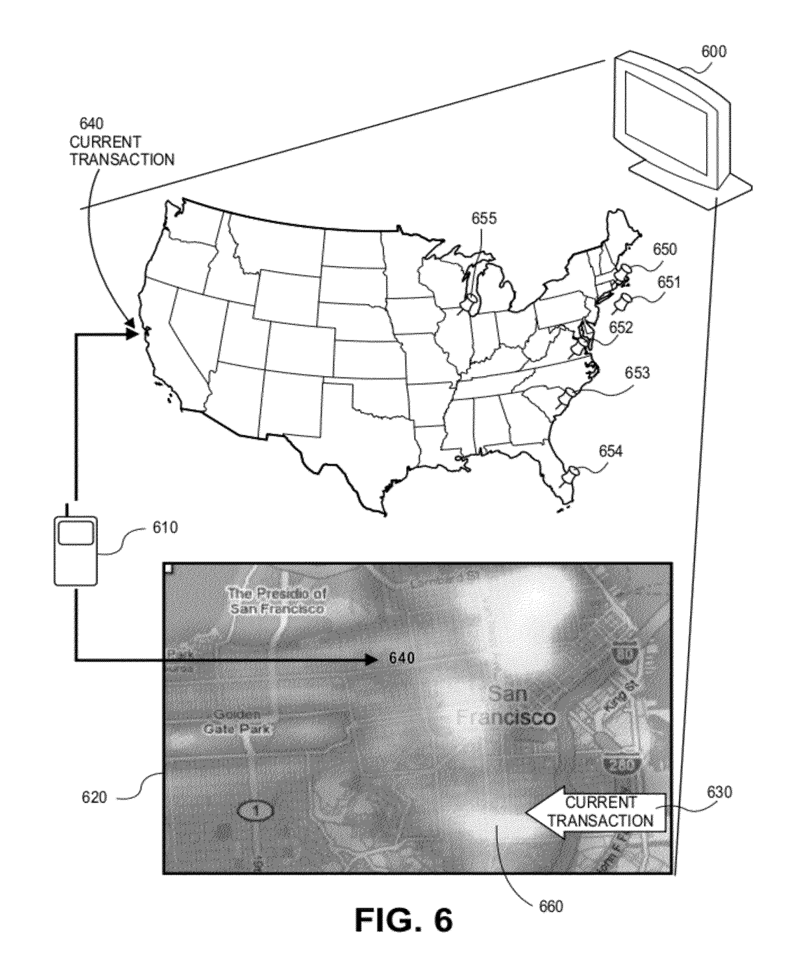

FIG. 6 shows an embodiment of the present invention that may be presented to an employee of an issuer who is responsible for analyzing potentially fraudulent transactions using a computer 600. Pinpoints 650-655 may represent areas where the consumer has conducted transactions regularly (e.g., 5 or more transactions). The current transaction 640 is outside of the regular patterns of the consumer; the account may be flagged for more detailed review.

The account having been flagged for review, an employee of the account issuer may look at the user interface shown. The user interface allows the employee to drill down to the particular transaction in question 630/640. Though the transaction is occurring outside of the consumer's normal areas, the transaction appears to be non-fraudulent in that both the phone 610 and the card present transaction 630 are in the same area. However, phone 610 and the current transaction 630 are not collocated which may indicate that the consumer's card was stolen while on a trip to San Francisco. Or, perhaps the consumer left his card in his hotel room. Using heat maps of the present invention, such as heat map 620, the employee may recognize this transaction is more likely than not fraudulent because the current transaction 630 was initiated from a high fraud area, as indicated by the bright spot 660.

Merchant Mapping

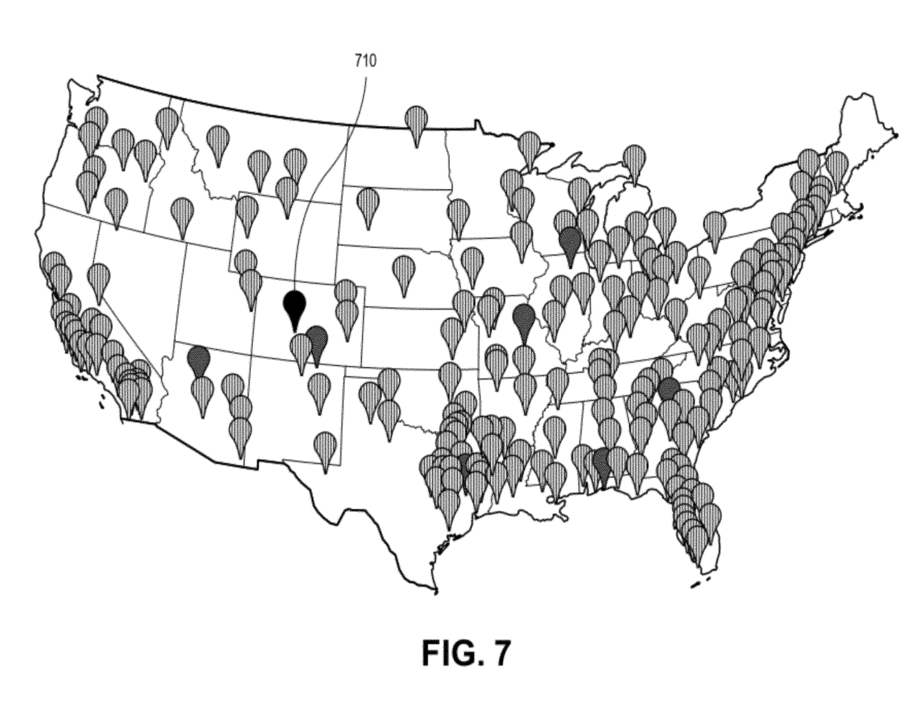

FIG. 7 shows a merchant map according to an embodiment of the present invention. It is beneficial for marketing and advertising to know the locations of merchants and merchants' point of sale (POS) terminals. For example, a payment network operator, such as Visa, knows some terminal information-based on merchant enrollment information, but Visa does not have the location of every merchant or every merchant's terminals. It would be burdensome to get merchants to provide and keep this information up to date. Since an ISO message has merchant information and terminal information, the location information provided by the phone could be used to map merchant location and merchant terminal locations. After a few enrolled customers made transactions at a particular merchant or merchant terminal, Visa would know with relative certainty the approximate location of the merchant/terminal. If the merchant/terminal moves, then the information can be updated based on enrolled customers' transaction and location data.

Merchant locations or merchant terminals can be mapped by using transaction-location data generated by enrolled customers. FIG. 7 shows a US map of confirmed merchant locations. Each pinpoint may has been confirmed by at least one enrolled account holder. In some embodiments, confirmation from more than one enrolled account holder may be desirable for increased accuracy. The heat map and underlying data may be dynamically updated as enrolled cardholders confirm the locations of merchants. For example, the pinpoints could represent Gap, Inc. locations.

As a merchant location or terminal map is generated, the map data can be cross-referenced with other data. For example, once the location of merchant 710 has been confirmed by a sufficient number (1, 2, 5, 10, 100, etc.) of enrolled account holders, that location can be associated with a unique merchant identifier for that location or a unique merchant terminal identifier for that terminal. At this point, it is known that merchant 710 is located at a specific geographic location, and this location data can be cross-referenced with other transaction data, for example, transaction of a cardholder who never enrolled, but made a transaction at merchant 710. In this manner, once merchant locations and merchant terminals are mapped with sufficient accuracy, heat maps can be generated using merchant and terminal identifiers along with transaction data of account holder who have not enrolled.

When more detailed information is known about where a merchant or merchant terminals are located, the location data can be used to maintain a dynamic list of the most recent zip codes where purchases were made for any given consumer or group of consumers. For example, a dynamic list of the most zip codes (e.g., a list of the most recent five zip codes where transactions have been made) where transactions were made may be maintained for each transaction account or cardholder. Zip code information can be extracted from authorization message, but it could also be obtained by locating the phone of an enrolled cardholder. This information is useful for targeted advertisements and offers because targeted offers or advertisements can be sent based on the most recent five zip codes where a consumer has been active.

Enrollment

In embodiments of the invention, location data is gathered after a cardholder enrolls and agrees to transmit his/her location data periodically by enrolling an in LBS program. FIG. 8 shows an embodiment of an enrollment screen 800. The consumer enters his of her information such as name 810 and email 820 in to a enrollment page or application. The consumer may enroll his or her transaction account and associate the transaction account with a location-enabled mobile device, such as a cell phone (830). To do so, the consumer may enter his or her transaction account number 840 and other account information, such as expiration date and billing zip code 850. The enrollment screen may also have “Program Information” such as “Consent to use location data” (860) and other “Terms and Conditions” (870) that are presented to the user. The enrollment information is transmitted using the buttons 880.

Exemplary Systems

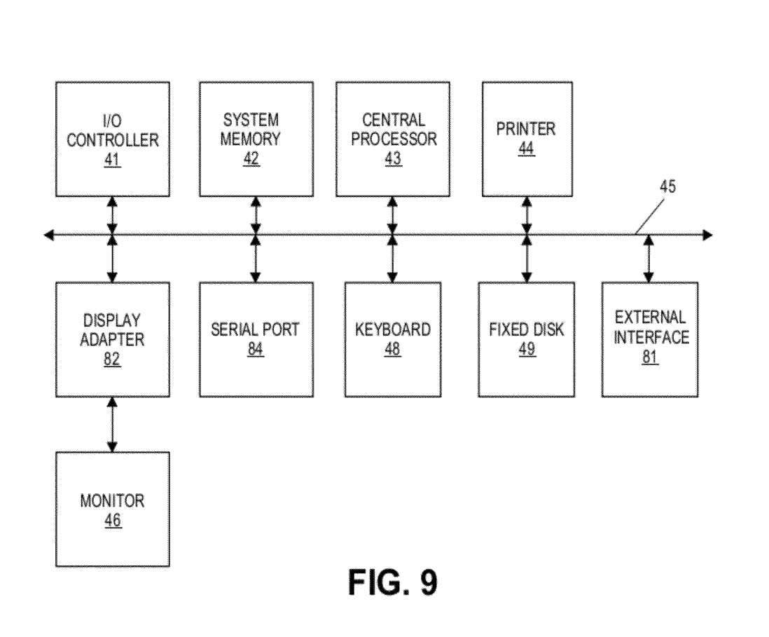

FIG. 9 is a high-level block diagram of a computer system that may be used to implement any of the entities or components described above. The subsystems shown are interconnected via a system bus 45. Additional subsystems such as a printer 44, keyboard 48, fixed disk 49, monitor 46, which is coupled to display adapter 82, and others are shown. Peripherals and input/output (I/O) devices, which couple to I/O controller 41, can be connected to the computer system by any number of means known in the art, such as serial port 84. For example, serial port 84 or external interface 81 can be used to connect the computer apparatus to a wide area network such as the Internet, a mouse input device, or a scanner. The interconnection via system bus 45 allows the central processor 43 to communicate with each subsystem and to control the execution of instructions from system memory 42 or the fixed disk 49, as well as the exchange of information between subsystems. The system memory 42 and/or the fixed disk 49 may embody a computer readable medium.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

It should be understood that the present technology as described above can be implemented in the form of control logic using computer software in a modular or integrated manner. Based on the disclosure and teachings provided herein, a person of ordinary skill in the art will know and appreciate other ways and/or methods to implement the present technology using hardware and a combination of hardware and software.

What is claimed is:

1. A method of generating electronic heat maps using location data and transaction data comprising:
receiving a first electronic message containing transaction data associated with a transaction account after a portable consumer device of an account holder is used for payment in a transaction;
receiving a second electronic message containing location data describing the location of a mobile device in the possession of the account holder and associated with the portable consumer device of the account holder;
analyzing, with a server computer, the location data and transaction data with a computer server and generating location-based transaction information; and
generating, with the server computer, an electronic heat map using the location-based transaction information.

2. The method of claim 1, wherein the heat map represents consumer spending in a particular geographic area.

3. The method of claim 2, wherein the heat map represents consumer spending over a particular period of time.

4. The method of claim 1, wherein the location data is derived from cellular tower triangulation.

5. The method of claim 1, further comprising electronically transmitting at least a portion of the heat map to an issuer of a payment account.

6. The method of claim 1, wherein the heat map is used to predict consumer behavior based on location-based transaction information.

7. The method of claim 6, wherein the predicting of consumer behavior includes determining a merchant that a consumer is likely to next visit based on prior location-based transaction information.

8. The method of claim 1, wherein the heat map is used to update a database of active spend zip codes.

9. The method of claim 1, wherein the heat map is used to map locations of a plurality of merchant terminals.

10. The method of claim 1, wherein the heat map represents fraudulent transactions.

11. A server computer for generating electronic heat maps using location data and transaction data comprising:
a transaction message parser module for receiving an electronic transaction message indicating that a transaction has been initiated using a portable consumer device, wherein the electronic transaction message comprises transaction-specific data;
an enrollment database containing a plurality of enrollment records, each enrollment record comprising a portable consumer device identifier;
a mobile device lookup module for determining a mobile device identifier based on the portable consumer device identifier;
a location query module, wherein the location query module is in operative communication with at least one cellular service provider capable of returning location data;
a transaction-location database that correlates the location of the mobile device and the transaction-specific data; and
a heat map data generation unit that generates a heat map based on the transaction-specific data.

12. The server computer of claim 11, wherein the heat map represents consumer spending in a particular geographic area and over a particular period of time.

13. The server computer of claim 11, wherein the location data is derived from cellular tower triangulation.

14. The server computer of claim 11, further comprising a merchant portal for a merchant to access the heat map.

15. The server computer of claim 11, further comprising an issuer portal for an issuer to access the heat map.

16. A method of generating electronic heat maps using location data and transaction data comprising:
receiving an electronic transaction message indicating that a transaction has been initiated using a portable consumer device, wherein the electronic transaction message comprises transaction-specific data;
determining, using a server computer, a mobile device associated with the payment account using the electronic transaction message;
initiating a location query, wherein the location query determines the location of the mobile device using cellular tower triangulation;
electronically correlating the location of the mobile device and the transaction-specific data; and
generating a heat map data point based on the correlation of the location of the mobile device and the transaction-specific data and recording the heat map data point to a heat map database.

17. The method of claim 16, wherein the transaction-specific data comprises a transaction account identifier, a transaction amount, or a transaction time stamp.

18. The method of claim 16, wherein the location of the mobile device comprises latitude and longitude coordinates.

19. The method of claim 16, wherein the location of the mobile device comprises a street address or zip code.

20. The method of claim 16, wherein the heat map represents spending in a particular geographic area over a particular period of time by credit card issuer.

21. A server computer for generating electronic heat maps using location data and transaction data comprising:
a transaction message parser module for receiving an electronic transaction message indicating that a transaction has been initiated using a portable consumer device, wherein the electronic transaction message comprises transaction-specific data;
an enrollment database containing a plurality of enrollment records, each enrollment record comprising a portable consumer device identifier;
a mobile device lookup module for determining a mobile device identifier based on the portable consumer device identifier;
a location query module, wherein the location query module is in operative communication with at least one cellular service provider capable of returning location data using cellular tower triangulation;
a transaction-location database that correlates the location of the mobile device and the transaction-specific data; and
a heat map data generation unit that generates a heat map based on the correlation of the location of the mobile device and the transaction-specific data.

22. The server computer of claim 21, wherein the heat map represents declined transactions over a particular period of time.

23. The server computer of claim 22, further comprising an issuer portal for an issuer to access the heat map.

24. The server computer of claim 21, wherein the heat map represents transaction volume.

25. The server computer of claim 21, wherein the heat map represents transaction volume by high dollar purchases in a specific geographic area.

26. The server computer of claim 26, further comprising a merchant portal for a merchant to access the heat map.

27. The server computer of claim 27, where in the merchant portal provides a user interface for the merchant to manipulate the heat map by zooming in, zooming out, changing the geographic area depicted by the heat map.

28. The server computer of claim 21, wherein the heat map represents velocity of spending.

29. The server computer of claim 21, wherein the location data comprises latitude and longitude coordinates.

30. The server computer of claim 21, wherein the location data comprises a street address or zip code.
